(19) United States
(12) Patent Application Publication
(10) Pub. No.: US 2011/0318616 A1
(43) Pub. Date: Dec. 29, 2011

(54) HIGH-VOLTAGE BATTERY AND METHOD OF CONTROLLING TEMPERATURE RISE OF THE SAME

(75) Inventors: Miok Kim, Seongnam (KR); Woosung Kim, Hwaseong (KR); Beomgyu Kim, Hwaseong (KR)

(73) Assignees: KIA MOTORS CORPORATION, Seoul (KR); HYUNDAI MOTOR COMPANY, Seoul (KR)

(21) Appl. No.: 12/942,342

(22) Filed: Nov. 9, 2010

(30) Foreign Application Priority Data
Jun. 23, 2010 (KR) 10-2010-0059515

(51) Int. Cl. H01M 10/50

(52) U.S. Cl. 429/62

(57) ABSTRACT

Provided are a high-voltage battery and a method of controlling temperature rise of the same, which can increase temperature of a battery module within a normal operation range and improve battery output features and durability without using an independent heating element, by balancing the temperature of the battery module with a balancing resistance of a sub-battery control system interposed between the battery modules, when the temperature of the battery module is less than reference temperature or there is a difference between temperature of a plurality of battery cells.

### CROSS-REFERENCE TO RELATED APPLICATIONS

The present application claims priority to Korean Patent Application Number 10-2010-0059515 filed Jun. 23, 2010, the entire contents of which application is incorporated herein for all purposes by this reference.

### BACKGROUND OF THE INVENTION

1. Field of the Invention

The present invention relates to a high-voltage battery and a method of controlling temperature rise of the same. In particular, the present invention provides a high-voltage battery that increases the temperature of a battery module to within a normal operating range and improves battery output features and durability without use of an independent heating element. More particularly, the high-voltage battery of the present invention uses a balancing resistor that is interposed between battery modules to increase the temperature of a battery module when the temperature is less than a reference temperature or when there is a difference between the temperature of a plurality of battery cells.

2. Description of Related Art

In general, high-voltage batteries used in electric vehicles and hybrid vehicles have different output features depending on the temperature of the high-voltage batteries. The lower the temperature of the high-voltage battery, the greater the reduction of available output. For example, there is a considerable reduction in the available output of a high-voltage battery in a vehicle that has been parked for a long time in a low-temperature environment (particularly about −10° C. or less), such as in the winter. As a result of this decreased output, the vehicle may shake when driven, which can provide an unpleasant and uncomfortable ride, and can further make acceleration of the vehicle very difficult.

Therefore, there is a need for a system and method for heating the high-voltage batteries until the output of the high-voltage batteries reaches a normal range, such that battery output is not decreased. Current systems and methods equip the high-voltage batteries with an independent heater, such as a PTC heater, which uses electric loads in order to heat the high-voltage batteries. However, these current systems use voltage generated by the high-voltage batteries to operate the heater, which is detrimental.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

The present invention provides a high-voltage battery and a method of controlling temperature rise of the high-voltage battery. In particular, the present invention provides a high-voltage battery and a method wherein the temperature of a battery module is increased to within a normal operation range, thereby improving battery output features and durability. Contrary to prior methods, the present invention does not require the use of an independent heating element to increase the temperature of the battery module. According to the present invention, balancing resistors are used to increase the temperature of the battery module. In particular, a sub-battery control system, which includes balancing resistors, is interposed between the battery modules. When the temperature of a battery module is less than a reference temperature, or when there is a difference between the temperatures of a plurality of battery cells, heat from the balancing resistors of the sub-battery control system increases the temperature of the battery module.

An exemplary embodiment of the present invention provides a high-voltage battery that includes: a plurality of battery modules, each including a plurality of battery cells; sub-battery control systems interposed between the battery modules, the sub-battery control systems being provided with balancing resistors; and a main battery control system in connection with, preferably in electrical connection with, the sub-battery control systems. In accordance with this embodiment, a method is provided for increasing the temperature of a battery module which comprises determining that the temperature of the battery module is lower than a level at which the battery modules output normal voltages, and increasing the temperature of the battery modules by using the balancing resistors of the sub-battery systems.

In accordance with a preferred embodiment, the sub-battery control systems increase the temperature of the battery modules using the balancing resistors, when the temperature differences among the battery cells of the battery modules are higher than a reference temperature difference.

Another exemplary embodiment of the present invention provides a method of controlling temperature rise of a high-voltage battery, which includes the steps of: a measuring the temperature of each battery using the sub-battery control systems interposed between the battery modules; comparing the measured temperature of each battery to determine whether the measured temperature is higher than a reference temperature; and balancing the battery cells to increase the temperature of the battery modules when it is determined that the measured temperature is equal to or less than the reference temperature.

In a preferred embodiment, the method further includes checking the measured cell difference, and comparing the measured difference to a reference difference to determine whether the difference of the measured temperature is equal to or greater than the reference difference.

If the measured cell difference is determined to be equal to or more than the reference difference, then cell balancing can be carried out tot balance the temperature of the battery modules by using the sub-battery control systems.

According to an exemplary embodiment of the invention, a high-voltage battery and a method of controlling temperature rise of the high-voltage battery is provided wherein the temperature of a battery module is increased to within a normal operating range, and wherein battery output features and durability are improved without using an independent heating element. In particular, when the temperature of the battery module is less than a reference temperature or when there is a difference between the temperatures of a plurality of battery cells, the temperature of the battery module is balanced and controllably increased using a balancing resistance from a sub-battery control system interposed between the battery modules.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a view illustrating a high-voltage battery according to an exemplary embodiment of the present invention.

FIG. 2 is a flowchart illustrating a method of the present invention for controlling temperature rise of the high-voltage battery shown in FIG. 1.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

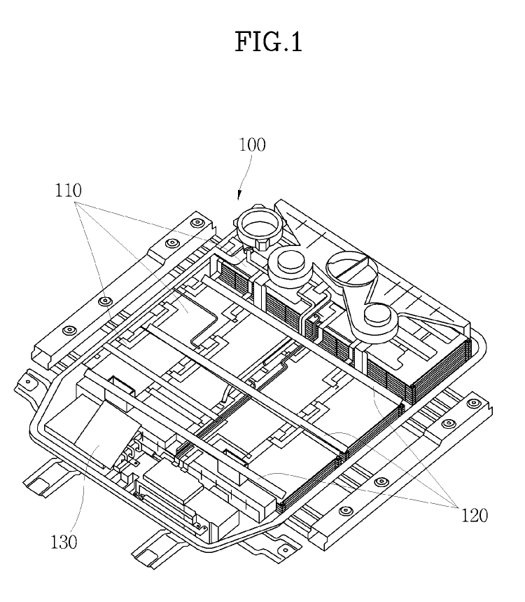

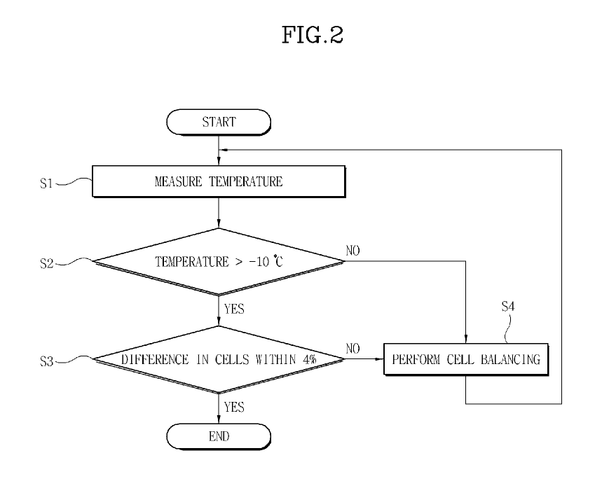

One embodiment of a high-voltage battery according to the present invention is illustrated in FIG. 1. One embodiment of a method for controlling temperature rise of a high-voltage battery, such as the high-temperature battery 100 shown in FIG. 1, is further described by way of example in connection with the flowchart provided in FIG. 2.

As generally shown in FIG. 1, a high-voltage battery 100 is provided with battery modules 110, sub-battery control systems 120, and a main battery control system 130 which are configured and arranged to control the temperature rise of the high-voltage battery 100.

In particular, according to this embodiment, the high-voltage battery 100 is formed of a plurality of battery modules 110. In turn, the battery modules 110 comprise of a plurality of battery cells which can be connected in series.

As shown, sub-battery control systems 120 are interposed between the battery modules 110. The sub-battery control systems 120 are configured and arranged to measure the temperature of each battery module 110, and to control the temperature of each battery module 110.

Preferably, each sub-battery control system 120 includes one or more balancing resistors for measuring the temperature of each battery module 110, and controlling the temperature of battery modules 110 based on the measured temperature of battery modules 110. In particular, the temperature of the battery modules 110 is increased by the sub-battery control system 120, which is heated by the balancing resistors. In a preferred embodiment, the sub-battery control system 120 includes a sensing unit (not shown) that measures the temperature of the battery modules 110, and a balancing unit (not shown) which includes balancing resistors to control the temperature of battery module 110 based on the sensed temperature.

In the exemplary embodiment shown in FIG. 1, the sub-battery control system 120 is mounted around an inlet path for cooling the battery module 110, such that cooling air is supplied to the battery module 110 through sub-battery control system 120, for example by a cooling fan. Thus, as the air is provided, for example by operating the cooling fan, the battery module 110 can be heated by the air which can be first heated by the balancing resistor of sub-battery control system 120.

As further shown in the exemplary embodiment in FIG. 1, a main battery control system 130 can be electrically in connection with the sub-battery control system 120 to control the temperature of the battery module 110 using the balancing resistor. Thus, when the temperature of the battery module 110 is lower than a level required for normal voltage output, the main battery control system 130 increases the temperature of the battery modules 110 up to a level for vehicle operation by using the balancing resistor of the sub-battery control system 120.

In accordance with a preferred embodiment, a high-voltage battery having this configuration and a method of controlling temperature rise of the high-voltage battery first measures the temperature of each battery module 110 using the interposed sub-battery control systems 120 to determine whether the temperature of battery modules 110 is at a level required for normal vehicle operation when the ignition is turned on in the vehicle. Thus, the sub-battery control systems 120 sense the temperature of each battery module 110 in the measuring temperature (S1) stage shown in FIG. 2.

After the measuring temperature (S1) stage, the method proceeds to a comparing temperature (S2) stage wherein it is determined whether the temperatures of the battery modules 110 sensed in the measuring temperature (S1)stage are higher than a battery reference temperature for normal vehicle operation. In particular, the reference temperature is set to −10° C., which is the minimum temperature for normal output of battery modules 110. Thus, in the comparing temperature (S2) stage, it is determined whether the temperature of battery modules 110 measured by sub-battery control systems 120 is −10° C. or more, which is the temperature required for the high-voltage battery 100 to output normal voltages.

If it is determined in the comparing temperature (S2) stage that the temperature of battery modules 110 is higher than the reference temperature, the method then proceeds to a checking cell difference (S3) stage. In this stage, it is determined whether the temperature differences of battery cells of each battery module 110 are higher than a reference difference.

In the checking cell difference (S3) stage, if the cell difference is greater than 4%, which influences the output of the battery, then the method performs a cell balancing (S4) stage that balances the cells of battery modules 110 by using the balancing resistors of sub-battery control system 120. In particular, the balancing resistors balance the temperatures of battery modules 110 so that they are the same.

In particular, in the cell balancing (S4) stage, the cells of the battery modules 110 are balanced by using the balancing resistors to increase the temperature of battery modules 110 such that the high-voltage battery 100 provides normal output.

As discussed, the main battery control system 130 is heated by the balancing resistors of the sub-battery control system 120 to increase the temperature of battery modules 110. In an exemplary embodiment, in the cell balancing (S4) stage, the temperature of the battery module 110 is increased by air from a cooling fan, which is heated by the balancing resistors, so that that battery module 110 outputs normal voltages.

According to the present invention, the temperature of battery modules 110 can be balanced using the balancing resistors of sub-battery control systems 120 interposed between the battery modules 110. As such, using the present high-voltage battery and method, when the temperature of the battery modules 110 is the reference temperature or less or when there is a temperature difference in the battery cells, it is possible to improve battery output features and increase durability by increasing the temperature of battery modules 110 within a normal operation range, without using an independent heating element.

The above description is an exemplary embodiment for implementing a high-voltage battery and a method of controlling temperature rise of the high-voltage battery of the present invention and the present invention is not limited thereto. Accordingly, the present invention may be modified in various ways by those skilled in the art without departing from the scope of the present invention, which is described in the following claims, and the modifications should be construed as being included in the present invention.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A high-voltage battery comprising:
a plurality of battery modules, each battery module including a plurality of battery cells;
sub-battery control systems interposed between the battery modules, the sub-battery control systems further comprising balancing resistors; and
a main battery control system electrically connected with the sub-battery control systems,
wherein the sub-battery control system is configured and arranged to determine whether the temperatures of the battery modules are lower than a required level to provide normal output voltage,
and wherein the balancing resistors are configured and arranged to heat the battery cells of the battery modules to thereby increase the temperature of the battery modules, when the temperatures of the battery modules is lower than the required level.

2. The high-voltage battery as defined in claim 1, wherein the sub-battery control systems are configured and arranged to increase the temperature of the battery modules, using the balancing resistors, when the temperature differences of the battery cells of the battery modules are higher than a reference difference.

3. A method of controlling temperature rise of a high-voltage battery, the method comprising the steps of:
measuring the temperature of each battery module using sub-battery control systems interposed between the battery modules;
comparing the measured temperatures to a reference temperature; and
balancing the battery cells by increasing the temperature of the battery modules, when the measured temperature is equal to or less than the reference temperature.

4. The method of controlling temperature rise of a high-voltage battery as defined in claim 3, further comprising, when the measured temperature is higher than the reference temperature, checking battery cell difference by comparing the difference between the measured cell temperatures to a reference difference.

5. The method of controlling temperature rise of a high-voltage battery as defined in claim 4, further comprising, when the difference of the measured temperatures is equal to or greater than the reference difference, balancing the cells by balancing the temperature of the battery modules using the sub-battery control systems.
